(19) United States
(12) Patent Application Publication
(10) Pub. No.: US 2011/0017525 A1
(43) Pub. Date: Jan. 27, 2011

(54) METHOD AND APPARATUS FOR SENSING PROXIMITY TOUCH

(76) Inventors: Yoon-ki KIM, Seoul (KR); Hyun-soo KWAK, Yongin-si (KR)

Correspondence Address: NIXON PEABODY, LLP, 401 9TH STREET, NW, SUITE 900, WASHINGTON, DC, 20004-2128, US

(21) Appl. No.: 12/840,244

(22) Filed: Jul. 20, 2010

(30) Foreign Application Priority Data
Jul. 21, 2009 (KR) 10-2009-0066290

(51) Int. Cl. G06F 3/044

(52) U.S. Cl. 178/18.06

(57) ABSTRACT

Method and apparatus for sensing a proximity touch by accumulating delays generated by the proximity touch for at least a predetermined number of times. Compared to general touches, a proximity touch generates a smaller size of delay than the minimum size that a sensor can sense, so it is difficult for conventional touch sensors to sense a proximity touch. Accordingly, for detection of a proximity touch, the proximity touch should generate a larger size of delay than the minimum size that a touch sensor can sense, and to this end, delays generated by a proximity touch are accumulated for at least a predetermined number of times. Then, the accumulated delays are compared with the minimum size that the sensor can sense so as to determine whether there is a proximity touch.

### TECHNICAL FIELD

The present invention relates to a method and apparatus for sensing a proximity touch, and particularly, to a method and apparatus for sensing a proximity touch by accumulating delays generated by the proximity touch for at least a predetermined number of times.

### BACKGROUND ART

Recently, products equipped with a touch screen, for example, smart phones, etc. have been in general use in order to provide a more convenient interface to users, and a method for sensing touches delicately has been required.

“General touch” refers to a state where a user touches, i.e., contacts, a sensor. Meanwhile, a user touches a sensor, but the user may fail to completely contact the sensor for any reason. For example, referring to FIGS. 1a and 1b, FIG. 1a illustrates a generally expected touch image (i.e., general touch), whereas FIG. 1b illustrates that a user (the finger) does not contact a touch sensor, but the finger is located near the sensor, thereby causing a change in the capacitance. In other words, as illustrated in FIG. 1b, compared to general touch, a state where a user intends to touch a sensor, but fails to completely contact the sensor is referred to as a “proximity touch,” and there are times when it is necessary to sense a proximity touch. Accordingly, the present invention provides a method and apparatus for sensing a proximity touch.

Meanwhile, a touch sensor includes a capacitor, and when the touch sensor is touched, the capacitance of the capacitor is changed, and the sensor can sense the touch through the amount of change in the capacitance. In this regard, the amount of change in capacitance C_{touch} according to general touch and proximity touch is explained with reference to FIGS. 1a and 1b.

Following Equation (1) shows the value of capacitance C_{touch} varying depending on the general touch.

C_{touch}=(∈ᵣ×∈₀)×A/D1 Equation (1)

In the Equation, A represents the area of a plate; D1 represents the distance between plates; and ∈ᵣ and ∈₀ represent the relative dielectric constant and air dielectric constant of dielectric, respectively.

Meanwhile, following Equation (2) shows the value of capacitance C_{touch} varying depending on the proximity touch.

C_{touch}=[(∈ᵣ×∈₀)×A/D1]//[(1×∈₀)×A/D2] Equation (2)

In the Equation, D2 represents the distance between a plate on the top and a finger.

Comparing Equation (2) with Equation (1), it can be expected that the amount of change in capacitance C_{touch} by a proximity touch is smaller than the amount of change in capacitance C_{touch} by a general touch.

Hereinafter, proximity touches in conventional touch sensors will be described.

FIG. 2a illustrates a touch sensor according to prior art, i.e., a touch sensor by RC charging and discharging. The touch sensor of FIG. 2a may be divided into an inner portion (220) of a chip for determining whether there is a touch and an outer portion (230) of the chip for sensing a touch (by generating a difference of capacitance by touch). The outer portion (230) of the chip may comprise a sense input module (236) which a user touches, and capacitors (232 and 234). The capacitance of the capacitor (234) has a fixed value, and the capacitance of the capacitor (232) may vary upon sensing touches.

The inner portion (220) of the chip comprises a module (226) for supplying power, the module consisting of NMOS and PMOS. Further, the inner portion (220) may comprise a comparator (222) and a counter (224) for determining whether there is a touch based on the sum of the capacitances of the capacitors (234 and 232) that can vary according to touches. For example, in case of determining touch according to voltage discharge (i.e., in case of determining whether there is a touch by using a path (255)), the voltage of an entire circuit changes depending on C_{touch} of a sense input module (236), and the comparator (222) compares the voltage of the circuit with a predetermined value (Vref) and increments the counter (224) when the voltage of the circuit is equal to or less than Vref.

The operation of the touch sensor of FIG. 2a will be described below with reference to FIG. 2b.

FIG. 2b illustrates that in case a sense input module in FIG. 2a senses a general touch or a proximity touch, voltage is discharged according to the touch. To be specific, FIG. 2b illustrates that voltage is discharged into a direction (255) as in FIG. 2a, and the horizontal axis represents time and the vertical axis represents voltage, and the slope of the graph may be determined by time constant τ(=Rᵢₙₜ×C; C represents the sum of C_{fix} and C_{touch}). The dotted line (272) illustrated in FIG. 2b shows a case of no touch, the solid line (274) shows a case of proximity touch, and the dot-dash line (276) shows a case of general touch. Compared to general touch (276), the variance of the wave shape of the proximity touch (274) is almost similar to that of the case of no touch (272). In other words, the difference between the capacitance of the general touch (276) and the capacitance of no touch (272) (i.e., delay: 284) is large, whereas the difference (282) between the capacitance of the proximity touch (274) and the capacitance of no touch (272) is very small.

For example, assuming that a counter (224) has a frequency of 20 MHz, the capacitance (286) for increasing the counter (224) should be at least 50 nF, and when actual noise is considered, should be at least 100 fF. In addition, assuming that Rint is 1Meg and C_{fix} is 5 pF, time constant τ when there is no touch is 5 μs (=1Meg×5 pF), and assuming that the variance of C_{touch} caused by general touch is 1 pF, time constant τ of general touch is 6 μs (=1Meg×(5 pF+1 pF)). To be specific, compared to the case of no touch, a general touch has 1 μs difference (284), and when counted with a counter (224) with a frequency of 20 MHz, it is counted 20 times. In other words, compared to the case of no touch, a general touch has a difference of time constant that is large enough for the counter (224) to count. However, in case of proximity touch, if it is assumed that the area (A) of a plate used in a sense input module (236) of a touch sensor is 10 mm×10 mm and the distance (D) between a user and the plate is 10 mm, C=88 fF=8.854×10⁻¹² F/m×(∈ᵣ×A×D)=8.854 f×(1×100×10), and this value is smaller than the capacitance value 100 fF, the required minimum value. In other words, the difference (282) between the capacitances of proximity touch and that of no touch is smaller than the minimum difference (286) that the counter (224) can count, and thus the counting is difficult.

Thus, it is difficult for the touch sensor of FIG. 2a to sense a proximity touch.

Meanwhile, FIG. 3a illustrates another touch sensor according to prior art, i.e., a touch sensor using current sources. The touch sensor of FIG. 3a may be divided into an inner portion (320) of a chip for determining whether there is a touch and an outer portion (330) of the chip for sensing a touch (by generating a difference of capacitance by the touch). The outer portion (330) of the chip may comprise a sense input module (336) and capacitors (332 and 334) for sensing a touch.

The capacitance of the capacitor (334) has a fixed value, and the capacitance of the capacitor (332) may vary depending upon the touch.

The inner portion (320) of the chip comprises a current source (326) for supplying a current, and may further comprise a comparator (322) and a counter (324) for determining whether there is a touch based on the sum of the capacitors (332 and 334) varying depending on the touch. For example, in case of identifying a touch according to the change in voltage charge (i.e., in case of determining whether there is a touch by using a path (350)), the voltage of a circuit changes depending on C_{touch} of a sense input module (336), and the comparator (322) compares the voltage of the circuit with a predetermined value (Vref) and increments the counter (324) when the voltage of the circuit is equal to or more than Vref. The operation of the touch sensor of FIG. 3a will be described below with reference to FIG. 3b.

FIG. 3b illustrates that in case a sense input module in FIG. 3a senses a general touch or a proximity touch, voltage is charged according to the touch. To be specific, FIG. 3b illustrates that voltage is charged into a direction (350) as in FIG. 3a, and the horizontal axis represents time and the vertical axis represents voltage, and the slope of the graph may be determined by a current source (326) and capacitors C (332 and 334; the sum of C_{fix} and C_{touch}). The dotted line (372) illustrated in FIG. 3b represents a case of no touch, the solid line (374) represents a case of proximity touch, and the dot-dash line (376) represents a case of general touch. Compared to a general touch (376), the variance of the wave shape of a proximity touch (374) is almost similar to that of the case of no touch (372). This is because in case of a general touch, the change in C_{touch} is large, whereas in case of a proximity touch, the change in C_{touch} is small (see Equations (1) and (2)). Accordingly, since the amount of change (382) in the capacitance of a proximity touch is smaller than the minimum amount of change (386) in the capacitance required to increment a counter, the counter cannot be incremented, and thus it is difficult for the touch sensor of FIG. 3a to sense a proximity touch.

As described above, it is difficult for conventional touch sensors to sense proximity touches. A sensor using a high frequency could be considered in order to solve the problem of such conventional touch sensors, but the sensor is difficult to actually implement in terms of costs or design. Therefore, hereinafter, a method and apparatus for sensing a proximity touch that is economic and has easy design will be described.

### PROBLEMS TO BE SOLVED

An object of the present invention is to sense a proximity touch efficiently by accumulating delays generated by the proximity touch.

Another object of the present invention is to provide a method for sensing a proximity touch, which enables simple design and cost reduction.

Another object of the present invention is to provide a method for sensing a proximity touch, with high resistance.

Yet another object of the present invention is to provide a flexible method for sensing both general touch and proximity touch since a user can determine the number of delay accumulation generated by the touch.

### SUMMARY

A proximity touch sensor of the present invention may comprise: an input module configured to include a capacitor, wherein the input module is further configured to receive an input from the outside of the sensor and change the capacitance of the capacitor; a comparator configured to compare the voltage changed by the capacitance with a reference voltage and reverse its output signal when the voltage changed by the capacitance is equal to the reference voltage, wherein the output signal of the comparator is used as a first clock signal; a sensing number counter configured to count the number of the first clock signal and output a signal when the counted result matches a sensing number; a sensing counter configured to count the number of a second clock signal until it receives the output signal of the sensing number counter; and a touch determining module configured to determine the input as a touch based on the output of the sensing counter.

The proximity touch sensor of the present invention may, preferably, further comprise a current supplying module configured to supply current to the sensor, wherein the current supplying module changes its phase according to the output signal of the comparator.

The proximity touch sensor of the present invention may, preferably, further comprise a current limiting module configured to determine the signal period of the sensor, wherein the current limiting module comprises a resistor, and further configured to reduce the noise of the sensor by changing the resistance of the resistor.

The proximity touch sensor of the present invention may, preferably, further comprise a sensing number generator configured to generate a sensing number, wherein the sensing number is a number which can be set according to outside conditions or the delay condition of the sensor system.

The proximity touch sensor of the present invention may, preferably, further comprise a clock generator configured to generate the second clock signal counted by the sensing counter.

The proximity touch sensor of the present invention may, preferably, further comprise a sensor enabling module configured to enable the sensor, wherein the sensor enabling module is disabled by the sensing number counter.

In the proximity touch sensor of the present invention, preferably, the comparator may be a Schmit trigger.

In the proximity touch sensor of the present invention, preferably, the touch determining module may set the number of the counted second clock signal as a reference value when there is no input from the outside of the sensor, and determine an input from the outside of the sensor as a touch when the number of the counted second clock signal exceeds the reference value.

A method for sensing proximity touch according to the present invention may, preferably, comprise: receiving an input from the outside of the sensor; changing the capacitance of a capacitor by the input; accumulating delay time for the capacitor to discharge for at least a predetermined number or more, wherein the delay time is determined by the change of the capacitance; and determining the input as a touch when the accumulated delay time is greater than or equal to a predetermined time, wherein the predetermined number is a number which can be set according to the condition of the outer sensor system or the delay condition of the inner sensor system, and wherein the predetermined time is an accumulated delay time for the capacitor to discharge for at least the predetermined number or more, when there is no input from the outside of sensor.

### BRIEF DESCRIPTION OF DRAWINGS

FIG. 1a illustrates an exemplary view of a typical touch.

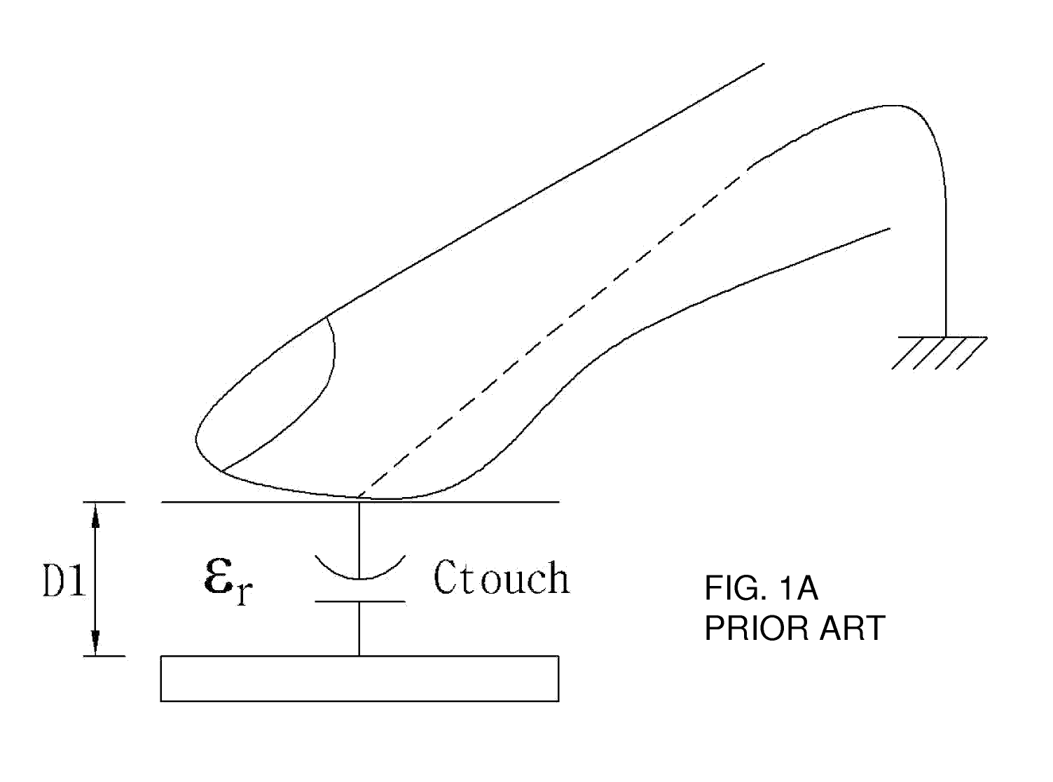

FIG. 1b illustrates an exemplary view of a proximity touch.

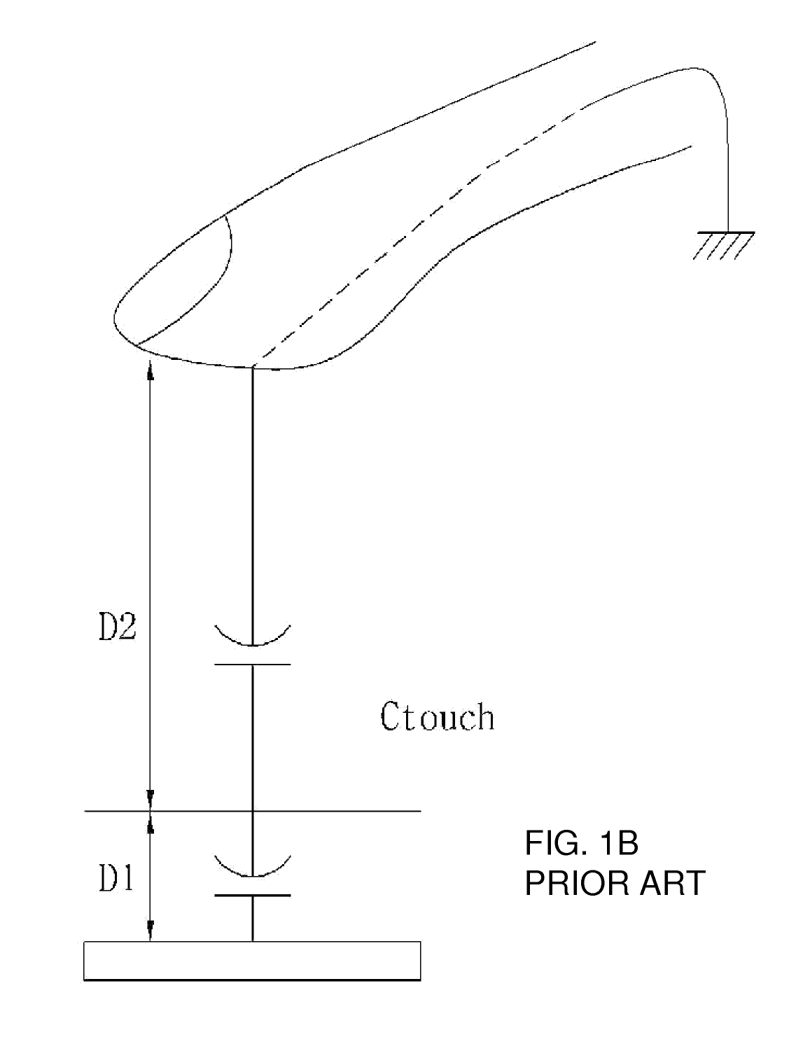

FIG. 2a illustrates a touch sensor according to prior art.

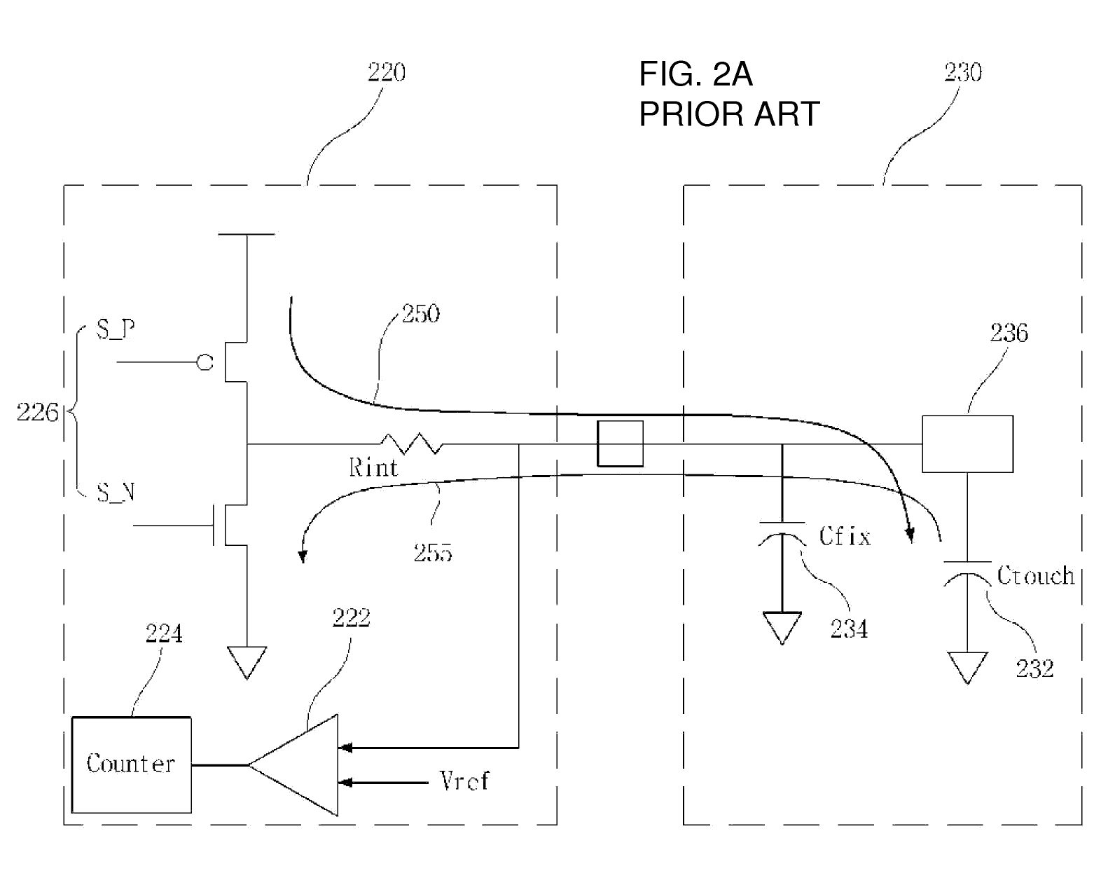

FIG. 2b illustrates a change in the voltage according to a general touch or proximity touch sensed by the sensing input module of FIG. 2a.

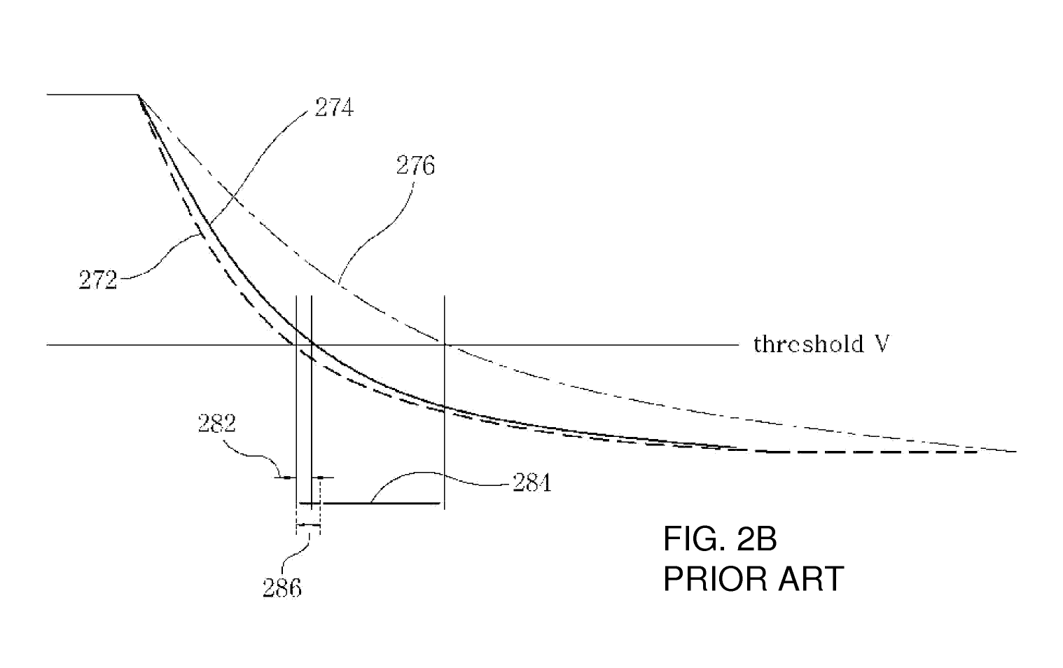

FIG. 3a illustrates another touch sensor according to prior art.

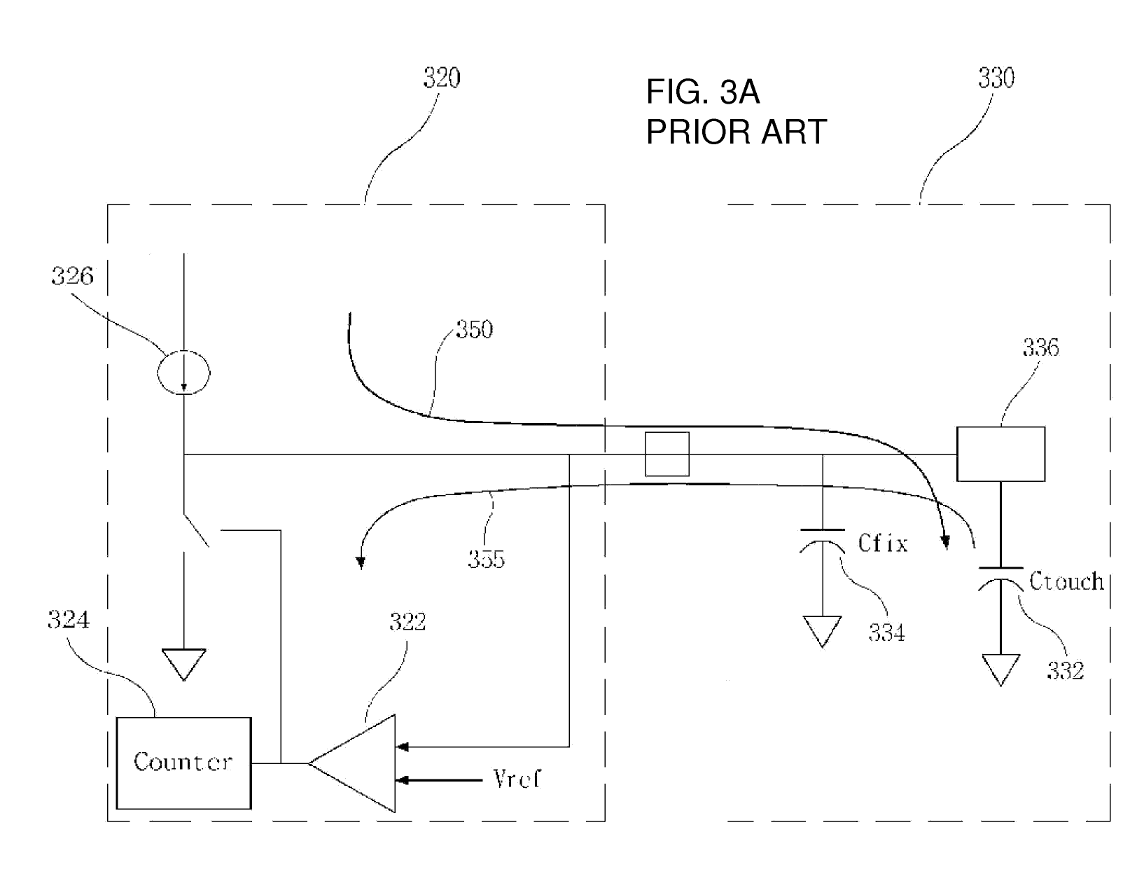

FIG. 3b illustrates a change of voltage according to each touch in case of sensing general touch or proximity touch by a sensing input module of FIG. 3a.

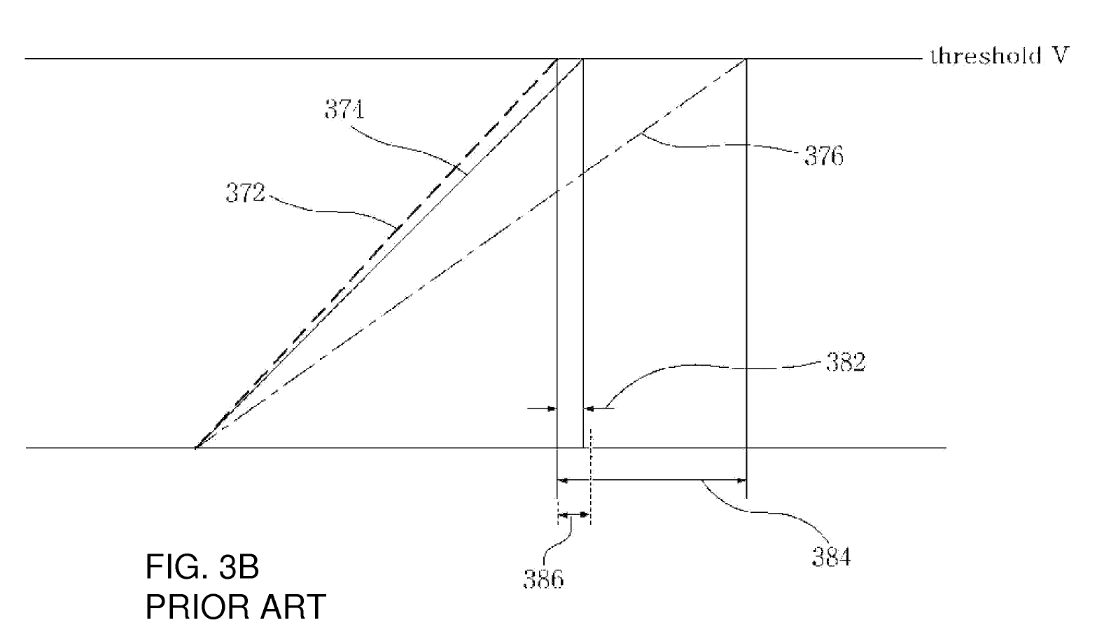

FIG. 4 illustrates a timing chart of a circuit operation for describing an operation principle of a proximity touch sensor of the present invention.

FIG. 5a illustrates a functional block diagram of a proximity touch sensor according to the present invention.

FIG. 5b illustrates a circuit of a sensing module of a proximity touch sensor according to the present invention.

FIG. 6 illustrates a timing chart of a circuit operation of FIG. 5a.

FIG. 7 illustrates one example of a current limiting module of FIG. 5a.

### DETAILED DESCRIPTION

According to the present invention, a proximity touch can be effectively sensed. In addition, according to the present invention, a touch sensor has a simple design and cost reduction. Further, according to the present invention, a touch sensor has high noise resistance. Moreover, according to the present invention, a touch sensor can flexibly sense both general touches and proximity touches.

Hereinafter, embodiments of the present invention will be described with reference to the drawings, wherein the same reference numerals are used to refer to the same components. The detailed description includes specific details for the purpose of providing a thorough understanding of the invention. However, it will be apparent to those skilled in the art that the invention may be practiced without these specific details.

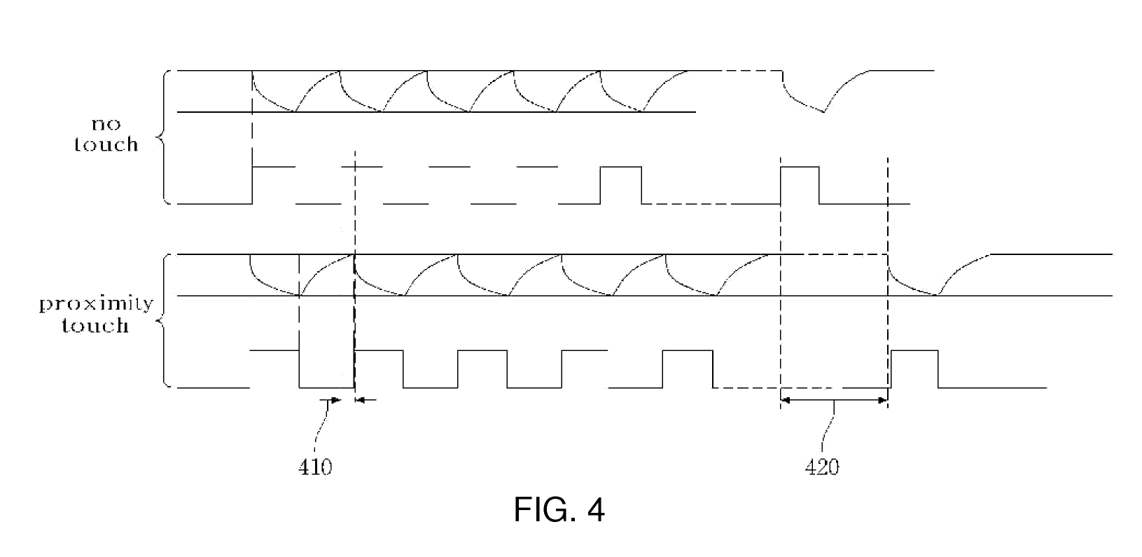

As described above, it is difficult to sense proximity touches because they make a small change in capacitance. Accordingly, the present invention accumulates delays generated by a proximity touch and determines whether there is a proximity touch based on the accumulated values. This will be described in detail with reference to FIG. 4.

FIG. 4 is a timing chart for describing an operation principle of a proximity touch sensor according to the present invention. Assuming that a proximity touch is sensed, the timing chart of FIG. 4 shows the change in the voltage of the proximity touch by comparing it with a case of no touch, where the horizontal axis represents time and the vertical axis represents voltage. In case of sensing a proximity touch, a delay (410) is generated compared to the case of no touch. As described above, the delay (410) is smaller than the minimum size that conventional sensors can sense. Accordingly, the present invention accumulates delay (410) and enables a sensor to sense the accumulated delay (420).

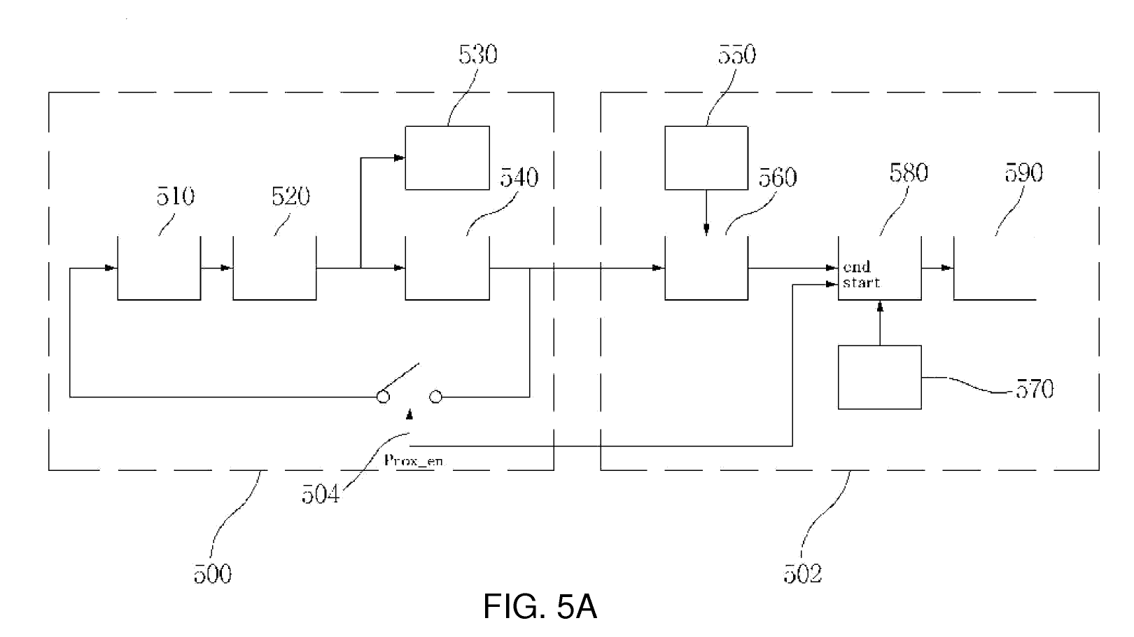

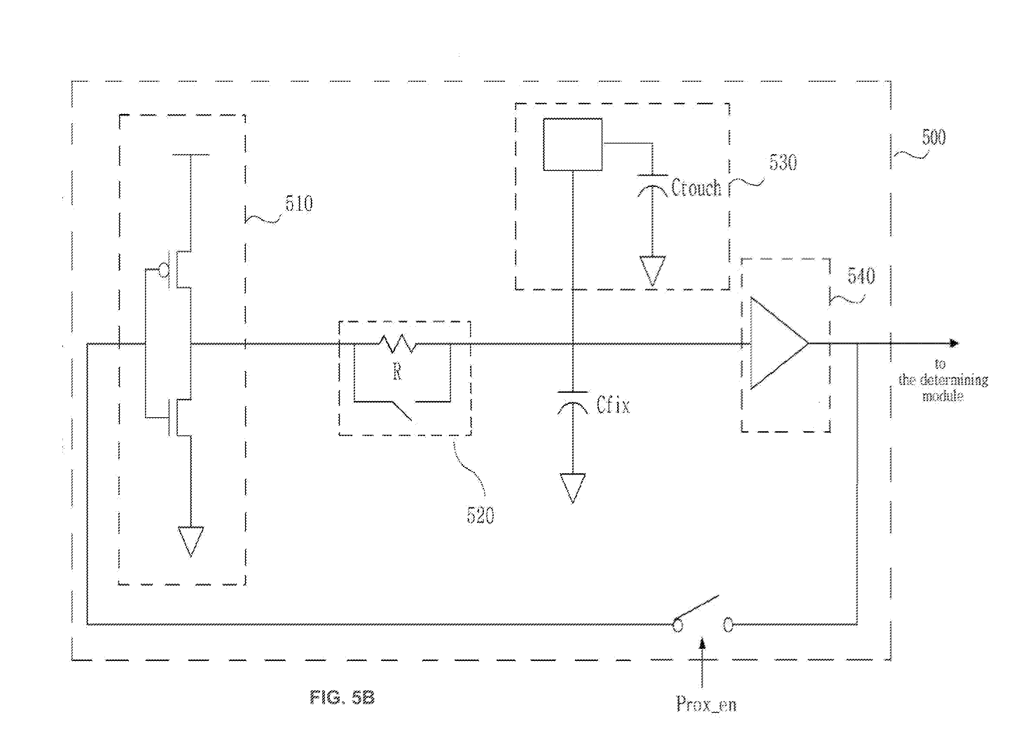

FIG. 5a is a functional block diagram of a proximity touch sensor according to the present invention. A proximity touch sensor of the present invention may comprise a sensing module (500) and a determining module (502).

The sensing module (500) senses a touch and changes the capacitance according to the sensed touch, and may comprise a current supplying module (510), a current limiting module (520), an input module (530), and a comparator (540). In addition, the determining module (502) counts the number of clocks during the operation time of the sensing module (500) and determines whether the touch sensed by the sensing module (500) is acceptable based on the counted clock. The determining module (502) may comprise a sensing number generator (550), a sensing number counter (560), a clock generator (570), a sensing counter (580), and a touch determining module (590).

The sensing module (500) may comprise a current supplying module (510) configured to supply current to an entire circuit, a current limiting module (520) configured to determine the period of the entire circuit functioning, an input module (530) configured to generate a difference between the capacitance when there is no touch and the capacitance when there is, and a comparator (540) configured to compare the voltage of the sensing module (500) with a reference voltage. Referring to FIG. 5b, respective functional block diagrams comprised in the sensing module (500) will be described below.

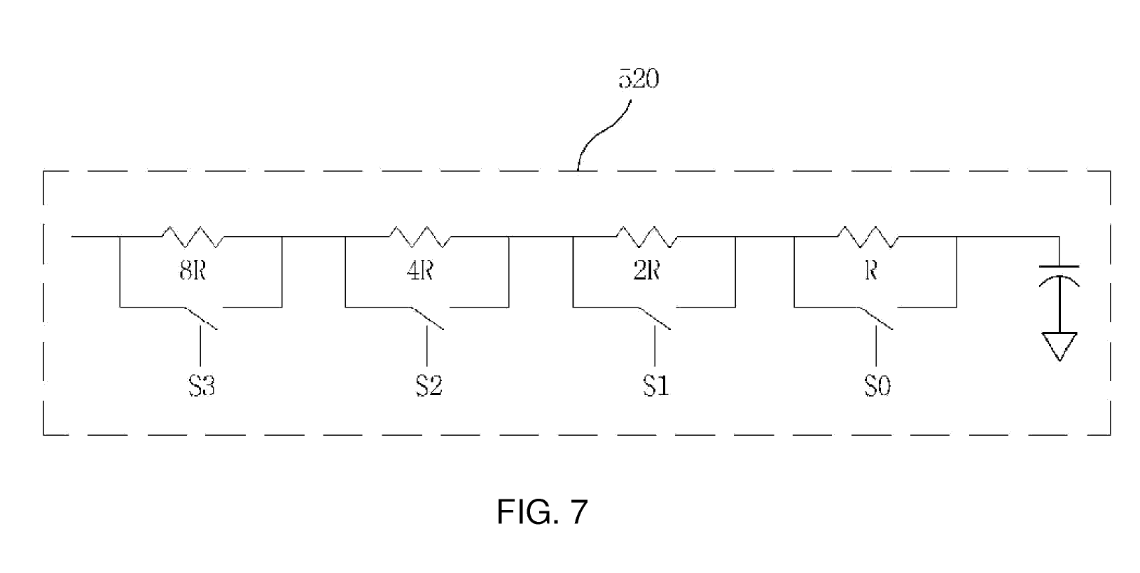

The current supplying module (510) consists of NMOS and PMOS, and supplies VDD/GND, two-way current and receives the output of the comparator (540) as an input. The current limiting module (520) comprises a resistor, and may determine delays based on the resistor and the capacitance of the next end. More details for the current limiting module (520) will be described with reference to FIG. 7. The input module (530) includes a capacitor (C_{touch}), and a difference in the capacitance of a capacitor (C_{touch}) can be generated depending on whether there is a touch. The comparator (540) comprises a maximum threshold (V_{high}) and a minimum threshold (V_{low}) as reference voltages, and compares the voltage of the sensing module (500) with the maximum threshold (V_{high}) and the minimum threshold (V_{low}). As a result of comparison, the comparator reverses its output whenever the circuit voltage reaches the maximum or minimum threshold, so that the voltage of the circuit of the sensing module (500) has a value between the maximum and minimum threshold (V_{high} and V_{low}). Here, the comparator (540) may be a Schmit trigger, and the constitution of a Schmit trigger is obvious to those skilled person in the art.

The determining module (502) may comprise a sensing number generator (550) configured to determine the number of sensing, a sensing number counter (560) configured to receive an output from the comparator (540) of the sensing module (500), a clock generator (570) configured to provide a clock signal to a sensing counter (580), the sensing counter (580) configured to receive the output of a prox_en switch (504) and the sensing number counter (560) as an input, and a touch determining module (590) configured to receive the output of the sensing counter (580).

The sensing number generator (550) may determine the sensing number of the sensing number counter (560), where this may vary depending on the outside condition or the delay condition of the system.

For example, in case of a proximity touch sensor for sensing both proximity touches and general touches, a user can set a small sensing number for sensing general touches, and a user can set a large sensing number for sensing proximity touches, and in case where the value of the delay generated by the sense of the input module (530) is high, a user can set a small sensing number. In other words, a user can set a sensing number generated by using the sensing number generator (550). The sensing number counter (560) receives a sensing number from the sensing number generator (550) and receives an output from the comparator (540) and uses the output of the comparator (540) as a clock signal. The sensing number counter (560) counts the output of the comparator (540) as the clock signal and outputs a value to the sensing counter (580) when the counted number has the same value as the sensing number set by the sensing number generator (550). The clock generator (570) generates a clock signal for the sensing counter (580), and preferably, generates clock signal as fast as possible to sense a proximity touch more delicately. The sensing counter (580) starts an operation (counter increment) according to the signal of a prox_en switch (504) and ends the operation upon the receipt of an output from the sensing number counter (560). During a predetermined time set by the sensing number counter (560) and the sensing number generator (550), the sensing counter (580) counts a number of clocks generated by the clock generator (570) and outputs the results to a touch determining module (590).

The touch determining module (590) determines whether a touch is generated based on the number of received clocks from the sensing counter (580). For example, if the sensing counter (580) completes n clock cycles during the sensing number set by the sensing number generator, the touch determining module (580) determines that there is a proximity touch, and if the sensing counter (580) fails to complete n clock cycles, the touch determining module (580) determines that there is no proximity touch. In other words, the touch determining module (580) determines whether a predetermined time set by the sensing number generator (550) and the sensing number counter (560) (i.e., the operation time of the sensing module (500)) is long enough to count n clocks of the sensing counter (580), and determines that there is a proximity touch if it is determined as a sufficiently large delay.

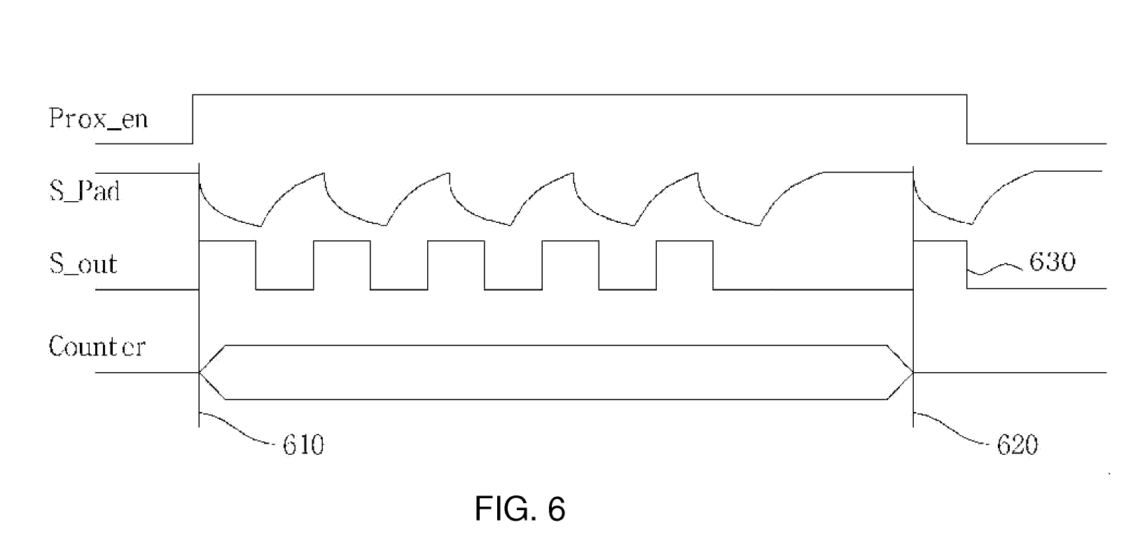

Referring to the timing chart for a circuit operation of FIG. 6, the operation of each module of a proximity touch will be described. Prox_en of FIG. 6 is a timing chart showing the activity of a Prox_en switch (504); S_Pad is a timing chart showing a change in the capacitance of the sensing input module (530) upon sense of touch; S_out refers to the output of the comparator (540); and Counter is a timing chart showing the output of the sensing counter (580). When the prox_en switch is on, a Prox_en signal is activated, and the operation of the sensing module (500) is started. In addition, the operation of the sensing counter (580) is started as the Prox_en signal is activated, and the output S_out signal of the comparator (540) switches to a high value.

If the S_out signal of the comparator (540) switches to a high value, the NMOS of the current supplying module (510) is turned on, so the output of the current limiting module (520) is changed to a low value. When the voltage of the circuit reaches the reference voltage of the comparator (540) as the voltage is gradually descending, the S_out signal of the comparator (540) is changed to a low value (i.e., the S-out signal of the comparator (540) is reversed from a high value to a low value). Since the S_out signal of the comparator (540) is at a low value, the PMOS of the current supplying module (510) is turned on, so the output of the current limiting module (520) switches to a high value. In order words, the sensing module (500) has a negative feedback structure during the operation time.

Meanwhile, the S_out signal of the comparator (540) is input to the sensing counter (560). The sensing number counter (560) uses the output of the comparator (540) as a clock signal and counts the output of the comparator (540) based on a sensing number as a reference value generated by the sensing number generator (550) until the counted number becomes equal to the reference value. The sensing number counter (560) outputs a signal if it is determined that the counted output of the comparator (540) reaches the reference value, and the signal ends the operation of the sensing counter (580) and makes the Prox_en switch off (630), thereby ending the operation of the sensing module (500). (That is, the negative feedback operation of the sensing module (500) and the operation of the sensing counter (580) are performed by a predetermined sensing number.)

As another embodiment, the sensing number counter (560) may count the number of the output values of the comparator (540) being reversed, and may perform the operations of the sensing module (500) and the sensing counter (580) based on the sensing number generated by the sensing number generator (550) as a reference value until the half of the counted number, wherein the half is an integer, becomes equal to the reference value.

The sensing counter (580) inputs the counted value to the touch determining module (590) from start (610) to end (620), and the touch determining module (590) determines that a touch is made when the received counted value is equal to or more than a predetermined value. Here, the predetermined value, based on which the touch determining module (590) determines whether a touch is made, is the output value of the sensing counter (580) when no touch is input, and this may vary depending on the touch sensor.

As described above, the present invention can effectively sense a proximity touch by accumulating delays generated when the proximity touch is made and comparing the accumulated delays with the minimum size that a sensor can sense by using a sensing module (500) and a determining module (502). In addition, according to the present invention, a touch sensor with low cost and simple design is possible utilizing only several circuit elements. Further, the present invention is economical because the present invention can make a touch sensor for sensing general touches as well as proximity touches by adjusting a sensing number generator (550).

Additionally, in case of accumulating delays generated by a proximity touch for at least a predetermined number of times as in the present invention, the noise resistance of the whole system can be increased. Generally, in case of sampling a delay once, noise properties show, so the noise resistance of the whole system is decreased, but if delays are accumulated several times as in the present invention, noise properties become supplementary to each other, so the noise resistance of the whole system can be increased.

Meanwhile, in addition to the method of increasing the noise resistance of the whole system as above, there is a method of increasing noise resistance by adjusting a current limiting module (520 of FIG. 5a).

FIG. 7 illustrates an example for increasing noise resistance by adjusting a current limiting module (520 of FIG. 5a) of FIG. 5a. As described above, the current limiting module (520) determines the cycle of the whole circuit functioning, and can adjust the discharging speed of the whole circuit.

In general, since feedback frequency F is proportional to 1/(2π×R×C), in a noisy environment, the noise resistance can be increased by changing R value. To be specific, if the resistance of a circuit is set to a high level, the amount of current flowing in the circuit would be small, so the system operation may be affected by outside noise, but if the resistance is set to a low level, the amount of current flowing in the circuit would be high, so effects by outside noise could be reduced. Accordingly, as illustrated in FIG. 7, the current limiting module (520) comprises one or more resistors connected to a switch, or comprises a variable resistor (not illustrated) so as to change the amount of current flowing in the circuit by adjusting a reference value (in general, the resistor is adjusted to set the resistance to a low level, so that the current flowing around the circuit become high), thereby reducing the problem of the system operation being affected by outside noise. In other words, a user may set the resistance of the current limiting module (520) to a low level so as to increase the resistance to the noise of the whole system.

As described above, according to the present invention, a user can use an economical proximity touch sensor with simple design and high noise resistance.

The embodiments of the present invention described above are only for examples, but the present invention is not limited to these embodiments. Various other changes and modifications can be made without departing from the spirit and scope of the invention. The present invention is not limited by the description described above, but only limited by the scope of the claims attached herewith.

1. A proximity touch sensor comprising:
an input module for receiving input from outside of the sensor, the input module being configured to include a capacitor and changing the capacitance of the capacitor according to the input;
a comparator for comparing the voltage changed by the capacitance with a reference voltage and reversing its output signal when the voltage changed by the capacitance is equal to the reference voltage, the output signal of the comparator being used as a first clock signal;
a first counter for counting the number of the first clock signal and outputting a signal when the counted result matches a sensing number;
a second counter for counting the number of a second clock signal until it receives the output signal of the first counter; and
a touch determining module for determining the input as a touch based on the output of the second counter.

2. The sensor of claim 1, further comprising a current supplying module for supplying current to the sensor, the current supplying module changing its phase according to the output signal of the comparator.

3. The sensor of claim 1, further comprising a current limiting module for determining the signal period of the sensor.

4. The sensor of claim 3, wherein the current limiting module comprises a resistor, and reduces the noise of the sensor by changing the resistance of the resistor.

5. The sensor of claim 1, further comprising a sensing number generator for generating a sensing number, the sensing number being a number which can be set according outside conditions or the delay condition of the sensor system.

6. The sensor of claim 1, further comprising a clock generator for generating the second clock signal counted by the second counter.

7. The sensor of claim 1, further comprising a sensor enabling module for enabling the sensor, the sensor enabling module being disabled by the first counter.

8. The sensor of claim 1, wherein the comparator is Schmit trigger.

9. The sensor of claim 1, wherein the touch determining module sets the number of the counted second clock signal as a reference value when there is no input from the outside of the sensor, and determines an input from the outside of the sensor as touch when the number of the counted second clock signal exceeds the reference value.

10. A proximity touch sensor comprising:
an input module for receiving input from outside of the sensor, the input module being configured to include a capacitor and changing the capacitance of the capacitor according to the input;
a comparator for comparing the voltage changed by the capacitance with a reference voltage and reversing its output signal when the voltage changed by the capacitance is equal to the reference voltage, the output signal of the comparator being used as a first clock signal;
a first counter for counting the number of the first clock signal and outputting a signal when the counted result matches a sensing number;
a sensing number generator configured to generate the sensing number, wherein the sensing number is a number which can be set according the condition of the outer sensor system or the delay condition of the inner sensor system;
a second counter for counting the number of a second clock signal until it receives the output signal of the first counter;
a clock generator for generating the second clock signal counted by the second counter; and
a touch determining module for determining the input as a touch based on the output of the second counter.

11. The sensor of claim 10, further comprising a current supplying module for supplying current to the sensor, the current supplying module changing its phase according to the output signal of the comparator.

12. The sensor of claim 10, further comprising a current limiting module for determining the signal period of the sensor, wherein the current limiting module comprises a resistor, and reduces the noise of the sensor by changing the resistance of the resistor.

13. The sensor of claim 10, further comprising a sensor enabling module for enabling the sensor, the sensor enabling module being disabled by the first counter.

14. The sensor of claim 10, wherein the comparator is Schmit trigger.

15. The sensor of claim 10, wherein the touch determining module sets the number of the counted second clock signal as a reference value when there is no input from the outside of the sensor, and determines an input from the outside of the sensor as touch when the number of the counted second clock signal exceeds the reference value.

16. A method for sensing proximity touch comprising:
receiving an input;
changing the capacitance of a capacitor by the input;
accumulating delay time for the capacitor to discharge for at least a predetermined number, the delay time being determined by the change of the capacitance; and
determining the input as a touch when the accumulated delay time is greater than or equal to a predetermined time.

17. The method of claim 16, wherein the predetermined number is a number which can be set according outside conditions or the delay condition of the sensor system.

18. The method of claim 16, wherein the predetermined time is an accumulated delay time for the capacitor to discharge for at least the predetermined number, when there is no input from the outside of the sensor.
